(19) United States
(12) Patent Application Publication
(10) Pub. No.: US 2019/0203594 A1
(43) Pub. Date: Jul. 4, 2019

(54) AUTOMATIC METHOD AND SYSTEM FOR DETECTING PROBLEMATIC GEOLOGICAL FORMATIONS AHEAD OF TUNNEL FACES

(71) Applicants: CHINA UNIVERSITY OF GEOSCIENCES (WUHAN), WUHAN (CN); INSTITUTE OF ROCK AND SOIL MECHANICS, CHINESE ACADEMY OF SCIENCES, WUHAN (CN)

(72) Inventors: YUYONG JIAO, WUHAN (CN); GUANGZHAO OU, WUHAN (CN); HAO WANG, WUHAN (CN); HOUJIANG ZHANG, WUHAN (CN); FEI TAN, WUHAN (CN); HUNAN TIAN, WUHAN (CN)

(21) Appl. No.: 16/232,005

(22) Filed: Dec. 25, 2018

(30) Foreign Application Priority Data
Dec. 28, 2017 (CN) 201711459939.4

(51) Int. Cl. E21B 49/00; G01V 1/50; E21B 47/12

(52) U.S. Cl. CPC E21B 49/003; E21B 47/12; G01V 1/50

(57) ABSTRACT

The present disclosure relates to an automatic system and method for detecting problematic geological formations ahead of tunnel faces. The automatic system includes a data acquisition module configured to acquire data, a data transmission module configured to transmit the data and a control and data analysis module configured to receive and analyze the data and determine the geological formations ahead of the tunnel faces. The data acquisition module includes at least one three-component detector and a processor. The three-component detector is installed in a borehole in a side wall of the tunnel. The data transmission module includes a synchronous communicator and a signal line with shielding properties. The synchronous communicator is connected with the three-component detector via the signal line. The control and data analysis module includes a host and a control and analysis procedure of the host. The host is connected with the synchronous communicator.

### CROSS REFERENCE TO RELATED APPLICATION

This application claims the priority of Chinese Patent Application No. 201711459939.4, entitled “Automatic Method and System Detecting Problematic Geological Formations ahead of Tunnel Faces”, filed on Dec. 28, 2017, the disclosure of which is incorporated herein by reference in its entirety.

### BACKGROUND OF THE INVENTION

### 1. Field of the Invention

The present invention relates to the field of problematic geological formations detection in a tunnel constructed by the drilling and blasting method, and particularly to an automatic method and system for detecting geological formations ahead of the tunnel faces.

### 2. Description of Related Art

The 21^{st} century is an era of great development of the tunnels and the underground spaces. With the expansion of the length and scale of the tunnel, complicated and variable geological conditions have been encountered more often. Lack of detection means in the early stage brings great threats to the tunneling safety, and could induce unexpected hazards such as water gushing, collapse, mud and sand inrush. The application of geological detecting technology in the construction period can help to uncover the problematic geological formation ahead of the tunnel faces in time, and to predict the possibility of construction hazards. The detecting results provide the basis to optimize support design and construction scheme. Up to now, some systematic studies have been conducted on the geological predictions with artificial seismic method at home and abroad, yet some deficiencies of this method still exist in the following aspects:

(1) Seismic Source Generation Mode;

Currently, to generate strong and high-frequency seismic waves, 24 small emulsion explosive charges are detonated successively along one side tunnel wall near the excavation face. In this way, drilling boreholes and charging emulsion explosive cost more than 2 hours. Also, because of the small amount of explosives (about 50 g-150 g), the seismic waves (especially the reflected seismic waves) have light energy which is hard to be acquired by the detectors, and thus affects the detecting distance (usually within 150 meters in front of the tunnel face) away from the tunnel face.

(2) Detector Layout Mode;

Detectors in tunneling geological prediction are used to receive the direct seismic waves and the reflected seismic waves. Nowadays, the most commonly used methods are the series of TSP (Tunnel Seismic Prediction) proposed by Amberg Technologies AG, Switzerland, and the series of TGP (Tunnel Geological Prediction) developed by Beijing Research Institute of Hydropower and Geophysical Surveying, China. In these two types of equipment, two detectors usually are installed in two boreholes drilled on the left and right side walls of the tunnel respectively. The two detectors record the direct reflected seismic waves separately. Then, through forward and inverse analysis, the geometric characteristics (distance, shape and size) of problematic geological formations such as faults, water-bearing structures, fractured zones, etc., can accordingly be predicted. However, in practical application, two detectors often come to contradictive results, causing great interference to project safety.

(3) Trigger Mode of Synchronous Signal;

The conventional equipment picks up the synchronous signal and start acquiring seismic wave when the emulsion explosive explodes. However, the detonator usually cannot be accurately triggered, which often has a time delay of milliseconds and thus results in a large error in the distance prediction.

### SUMMARY OF THE INVENTION

One aspect of the present disclosure relates to an automatic system for detecting problematic geological formations ahead of tunnel faces is provided.

The automatic system includes: a data acquisition module, configured to acquire data, and the data acquisition module includes at least one three-component detector and a processor, at least one borehole is drilled in a side wall of the tunnel, the three-component detector is placed in the borehole as follows: a x-component direction of the three-component detector is consistent with an axis direction of the tunnel and points to the direction of the tunnel face; a y-component direction of the three-component detector is perpendicular to the axis direction of the tunnel in a horizontal plane; a z-component direction of the three-component detector is perpendicular to the axis direction of the tunnel in a vertical plane; a data transmission module, configured to transmit the data, the data transmission module includes a synchronous communicator and a signal line with shielding properties, and the synchronous communicator is connected with the three-component detector via the signal line to receive data acquired by the data acquisition module; a control and data analysis module, configured to receive and analyze the data, and determine the geological information of the tunnel based on the data, the control and data analysis module includes a host and a control and analysts procedure of the host, and the host is connected with the synchronous communicator.

In some embodiments, three boreholes, namely, a first borehole, a second borehole and a third borehole are drilled in the side wall of the tunnel.

In some embodiments, the tunnel comprises a base which is perpendicular to the tunnel face, the first borehole, the second borehole, and the third borehole are drilled parallel to the base plate of the tunnel and perpendicular to an axis direction of the tunnel.

In some embodiments, the data acquisition module includes three three-component detectors, and the three three-component detectors placed in the first borehole, the second borehole and the third borehole are named as the first three-component detector, the second three-component detector and, the third three-component detector, respectively.

In some embodiments, the three three-component detectors acquire the data independently and synchronously and the three three-component detectors are connected with each other via the signal line.

In some embodiments, lithium-based grease is used as a coupling medium to fill space between the three-component detector and borehole wall.

In some embodiments, the three-component detector acquires the data automatically, converts analogue signal to digital signal, stores the data, transmits the data and supplies power independently.

In some embodiments, the synchronous communicator is connected with the host via wire or wireless connection.

In some embodiments, the signal line is an alternating current transmission line.

In some embodiments, the synchronous communicator transmits the data acquired by the data acquisition module to a server.

In some embodiments, the server includes a particular server and a cloud server.

In some embodiments, the synchronous communicator is placed at a tunnel entrance of the tunnel.

In some embodiments, the borehole is parallel to a base plate of the tunnel and perpendicular to an axis direction of the tunnel.

In some embodiments, the host sets at least one acquisition parameter of the three-component detector, transmits an instruction to the data acquisition module, displays and records the data.

Another aspect of the present disclosure relates an automatic method for detecting problematic geological formations ahead of tunnel faces is provided. The automatic method includes: drilling at least one borehole in a side wall of the tunnel; placing one three-component detector in each borehole respectively; filling lithium-based grease in the borehole; turning on a host and initializing each serial port of the host, and the host, is connected with a synchronous communicator which is connected with the three-component detector via, a signal line; setting at least one acquisition parameter via a control and analysis procedure of the host and transmitting the acquisition parameter to a processor, and the processor is configured to control the three-component detector; passing back a ready response of the three-component detector to the control and analysis procedure of the host by the processor; exploding explosives at the tunnel face to form at least one artificial seismic wave and at least one reflected seismic wave forms when the artificial seismic wave propagates to the geological interface; acquiring at least one signal of the seismic wave according to the acquisition parameter and storing the signal of the seismic wave in a preset format by the three-component detector; transmitting the signal of the seismic wave to the host via the synchronous communicator by the three-component detector; and determining the geological formations ahead of the tunnel face based on an analysis of the signal of the seismic wave by the control and analysis procedure.

In some embodiments, the placing one three-component detector in each borehole respectively is conducted as follows: a x-component direction of the, three-component detector is consistent with an axis direction of the tunnel and points to the direction of the tunnel face, a y-component direction of the three-component detector is perpendicular to the axis direction of the tunnel in a horizontal plane, and a z-component direction of the three-component detector is perpendicular to the axis direction of the tunnel in a vertical plane.

In some embodiments, the filling lithium-based grease in the borehole is conducted as follows: filling the lithium-based grease in space of the borehole; and pressing hard the three-component detector to make the lithium-based grease fill the space between the three-component detector and the borehole walls.

In some embodiments, the acquisition parameter includes a sampling length, a sampling rate and a sampling trigger condition.

In some embodiments, the acquiring at least one signal of the seismic wave according to the acquisition parameter is conducted as follows: the three-component detector starts to acquire the signal of the seismic wave according to the acquisition parameter while the signal of the seismic wave received by the three-component detector reaches a set value, and the three-component detector automatically acquire the signal of the seismic wave in the blasting of tunneling every time.

In some embodiments, three boreholes are drilled in the side wall of the tunnel and three three-component detectors are placed in each borehole respectively, a first arrival seismic velocity of the surrounding rock is determined based on three arrival times that the three three-component detectors record the seismic wave first time respectively and distances from the three-component detectors to tunnel entrance respectively.

In some embodiments, a blast moment at the tunnel face is determined based on the first arrival seismic velocity and the distance from the tunnel face to the tunnel entrance.

Additional features will be set forth in part in the following description, and in part will become those people skilled in the art upon examination of the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

In order to more clearly illustrate the technical solutions of embodiments of the invention or the prior art, drawings will be used in the description of embodiments or the prior art will be given a brief description below. Apparently, the drawings in the following description only are some of embodiments of the invention, the ordinary skill in the art can obtain other drawings according to these illustrated drawings without creative effort.

FIG. 1 is an application scenario diagram of an exemplary automatic system for detecting problematic geological formations ahead of a tunnel face according to some embodiments of the present disclosure;

FIG. 2 is a schematic diagram of an exemplary tunnel according to some embodiments of the present disclosure;

FIG. 3 is a schematic diagram of an exemplary automatic system for detecting the problematic geological formations ahead of the tunnel face according to some embodiments of the present disclosure;

FIG. 4 is a schematic diagram of two exemplary sectional views of the tunnel in FIG. 1 and FIG. 2 according to some embodiments of the present disclosure;

FIG. 5 is a schematic diagram of an exemplary tunnel face in FIG. 1 and FIG. 2 according to some embodiments of the present disclosure;

FIG. 6 is a schematic diagram of an exemplary borehole of the tunnel in FIG. 1 and FIG. 2 according to some embodiments of the present disclosure;

FIG. 7 is a schematic diagram of an exemplary application scenario of the automatic system for detecting the problematic geological formations ahead of the tunnel face in FIG. 1 and FIG. 2 according to some embodiments of the present disclosure;

FIG. 8 is a flowchart illustrating an exemplary process for detecting the problematic geological formations ahead of the tunnel face according to some embodiments of the present disclosure;

FIG. 9 is a schematic diagram of three exemplary seismic waves recorded by the three three-component detectors respectively according to some embodiments of the present disclosure.

Wherein: 1-tunnel, 2-borehole, 2a-the first borehole, 2b-the second borehole, 2c-the third borehole, 3-three-component detector, 3a-the first three-component detector, 3b-the second three-component detector, 3c-the third three-component detector, 4-side wall, 5-tunnel face, 6-artificial seismic wave, 61-direct seismic wave, 7-reflected seismic wave, 8-geological interface, 9-signal line, 10-synchronous communicator, 11-host, 12-control and analysis procedure, 13-data acquisition module, 14-data transmission module, 15-control and data analysis module, 16-processor, 17-tunnel entrance, 18-server, 19-lithium-based grease, 20-explosives, 21-base plate.

### DETAILED DESCRIPTION OF THE PREFERRED EMBODIMENTS

The purpose of the invention is at the shortages of the state of prior art and provide are automatic method and system for detecting problematic geological formations ahead of the tunnel face constructed by methods of drilling and blasting. In this system, three detectors are installed in three boreholes drilled on one side tall of the tunnel respectively. High energy, seismic waves formed by tunnel excavation blasting are adopted as the seismic source which reduces drilling and emulsion explosive charging works. The data transmission uses the wireless transmission mode, which allows workers to operate the system outside of the tunnel and thus improve the working environment and reduce operational risk greatly. This method is easy to operate and takes less tunnel construction time. What's more, the system can automatically acquire the signal of the seismic wave in the blasting of the face every time. It can be used in other a underground space projects besides tunnels, such as shafts and cavities.

In accordance with various implementations, the mechanisms of the present invention are provided as described in more detail below.

In the following detailed description, numerous specific details are set forth by the way of examples in order to provide a thorough understanding of the relevant disclosure. However, it should be apparent to those people skilled in the art that the present disclosure may be practiced without such details. In other instances, well known methods, procedures, systems, components, and/or circuitry have been described at a relatively high-level, without detail, in order to avoid unnecessarily obscuring aspects of the present disclosure.

Various modifications to the disclosed embodiments will be readily apparent to those people skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

It will be understood that the term “system”, “unit”, “sub-unit”, “module”, and/or “block” used herein are one method to distinguish different components, elements, parts, section or assembly of different level in ascending order. However, the terms may be displaced by other expression if they may achieve the same purpose.

It will be understood that when a unit, module or block is referred to as being “on”, “connected to”, or “coupled to” another unit, module, or block, it may be directly on, connected or coupled to the other unit, module, or block, or intervening unit, module, or block may be present, unless the context clearly indicates otherwise. As used herein, the term “and/or” includes any and all combinations of one or more of the associated listed items.

The terminology used herein is for the purpose of describing particular example embodiments only and is not intended to be limiting. As used herein, the singular forms “a” “an” and “the” may be intended to include the plural forms as well, unless the context clearly indicates otherwise. It will be further understood that the terms “comprise”, “comprises”, and/or “comprising”, “include”, “includes” and/or “including” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawing(s), all of which form a part of this specification. It is to be expressly understood, however, that the drawing(s) are for the purpose of illustration and description only and are not intended to limit the scope of the present disclosure.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

The present disclosure relates to the field of problematic geological formations detection in the tunnel construction by drilling and blasting. Specially, the present disclosure relates to an automatic system and method for detecting problematic geological formations ahead of tunnel faces.

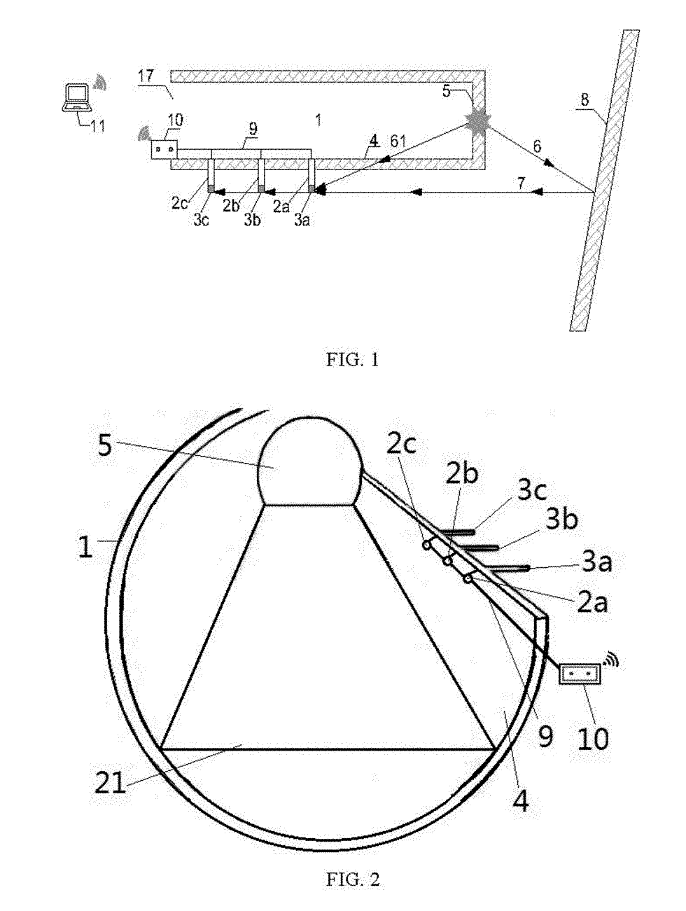

FIG. 1 is an application scenario diagram of an exemplary automatic system for detecting problematic geological formations ahead of a tunnel face 5 according to some embodiments of the present disclosure. FIG. 2 is a schematic diagram of an exemplary tunnel 1 according to some embodiments of the present disclosure. As shown in FIG. 1 and FIG. 2, the tunnel may include at least one side wall 4, a tunnel face 5, a tunnel entrance 17 and a base plate 21 located perpendicular to the tunnel face 5. A plurality of boreholes 2 may be drilled in the side wall 4 of the tunnel 1. In some embodiments, three boreholes 2 may be drilled, namely, a first borehole 2a, a second borehole 2b and a third borehole 2c. The first borehole 2a, the second borehole 2b and the third borehole 2c may be drilled in the same side wall 4 of the tunnel 1. The first borehole 2a, the second borehole 2b and the third borehole 2c may be drilled parallel to the base plate 21 of the tunnel 1 and perpendicular to an axis direction of the tunnel 1. In some embodiments, a depth of the borehole 2 may be 1.5 meters, a diameter or the borehole 2 may be 6 centimeters, the borehole 2 may be 1.5 meters distant from the base plate 21 of the tunnel 1, and the distance between two adjacent boreholes 2 may be 5-10 meters.

An artificial seismic wave 6 may be formed when explosives 20 are exploded at the tunnel face 5 as shown FIG. 5. For example, four explosives 20 may be evenly buried in center of the tunnel face 5. A reflected seismic wave 7 may be formed when the artificial seismic wave 6 propagates to and is reflected by the geological interface 8. The automatic system for detecting problematic geological formations ahead of the tunnel face may be configured to acquire and analyze at least one signal of the reflected sets as shown in FIG. 1.

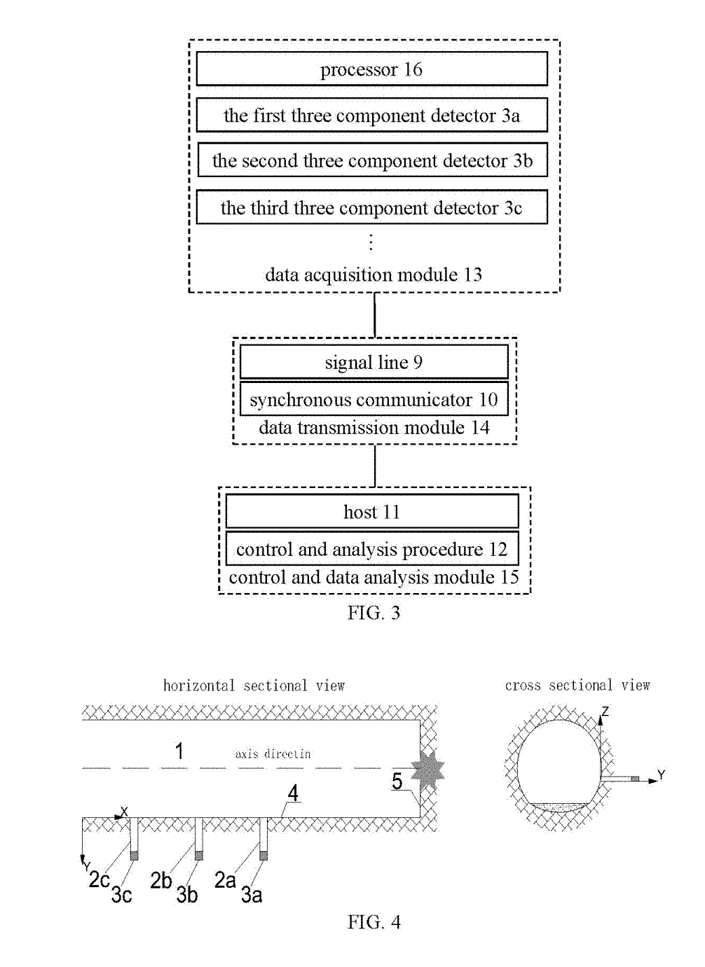

FIG. 3 is a schematic diagram of an exemplary automatic system for detecting the problem problematic geological formations ahead of the tunnel face 5 according to some embodiments of the present disclosure. As illustrated, the automatic system may include a data acquisition module 13, a data transmission module 14, a control and data analysis module 15, and/or any other suitable component for detecting the problematic geological formations ahead of the tunnel face 5 in accordance with various embodiments of the disclosure. The data acquisition module 13 may be placed in the tunnel 1. The control and data analysis module 15 may be placed outside the tunnel 1. The data acquisition module 13 may connect the control and data analysis module 15 via the data transmission module 14.

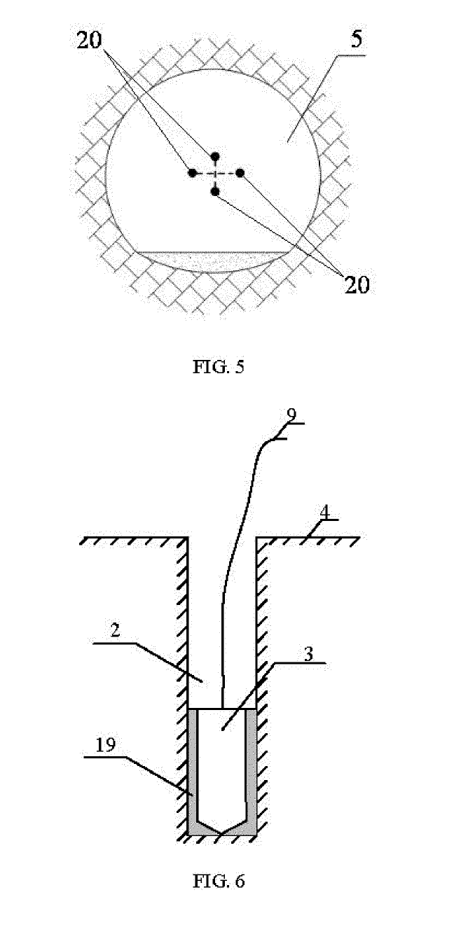

The data acquisition module 13 may be configured to acquire data, such as the signal of the reflected seismic wave 7. The data acquisition module 13 may include at least one highly integrated and intelligent three-component detector 3 and a processor 16. The three-component detector 3 may be configured to acquire the data automatically, convert analogue signal to digital signal, store the data, transmit the data and supply power independently. In some embodiments, the data acquisition module 13 may include three three-component detectors 3, namely, a first three-component detector 3a, a second three-component detector 3b and a third three-component detector 3c. The three-component detector 3 may be installed in the borehole 2, as shown in FIG. 6. Some artificial seismic wave 6, which is directly transmitted to the three-component detector 3, is named as direct seismic wave 61 (shown in FIG. 1). In some embodiments, the first three-component detector 3a, the second three-component detector 3b and the third three-component detector 3c may be placed in the first borehole 2a, the second borehole 2b and the third borehole 2c respectively. The processor 16 may be configured to control the three-component detector 3, for example, the processor 16 may control a time when the three-component detector 3 starts to acquire the data.

The data transmission module 14 may be configured to transmit the data acquired by the three-component detector 3 to some devices, such as the control and data analysis module 15. The data transmission module 14 may include a synchronous communicator 10 and a signal line 9 with shielding properties. The synchronous communicator 10 may be configured to transmit the data acquired by the three-component detector 3 to the control and data analysis module 15. The synchronous communicator 10 may be placed at the tunnel entrance 17 of the tunnel 1. In some embodiments, the synchronous communicator 10 may transmit the data acquired by the three-component detector 3 to a server 18. The server 18 may include a particular server and a cloud server. The signal line 9 may be configured to connect two devices, such as two three-component detectors 3. In some embodiments, the synchronous communicator 10 may be connected with the three-component detector 3 via the signal line 9. In some embodiments, the first three-component detector 3a, the second three-component detector 3b and the third three-component detector 3c may be connected with each other via the signal line 9. In some embodiments, the signal line 9 may be an alternating current transmission line.

The control and data analysis module 15 may configured to analysis the data transmitted from the synchronous communicator 10 and predict the geological condition of the tunnel 1 based on the data. The control and data analysis module 15 may include a host 11 and a control and analysis procedure 12 of the host 11. The host 11 may be configured to set at least one acquisition parameter of the three-component detector 3, transmit an instruction to the data acquisition module 12, display and record the data transmitted from the synchronous communicator 10. The control and analysis procedure 12 may be configured to control the data acquisition of the three-component detector 3 and analyze the data transmitted from the synchronous communicator 10. In some embodiments, the synchronous communicator 10 may connect with the host 11 via wire or wireless connection.

Only one operator may be needed to operate the automatic system. The operator may operate the automatic system remotely in a control room outside the tunnel 1 and no need to enter the tunnel 1, which greatly improving working conditions and reducing personnel risks. The automatic system may acquire the signal automatically every time when the tunnel face 5 is blasted by the explosives 20, and may truly realize automatic and continuous detecting problematic geological formations ahead of the tunnel face 5. Compared with conventional methods, this method may eliminate the previous work of drilling boreholes and packing explosives in the side wall 4 of the tunnel 1, which no longer occupies the construction time of the tunnel 1, reduces the labor intensity, speeds up the construction progress and reduces the operation risk.

FIG. 4 is a schematic diagram of two exemplary sectional views of the tunnel 1 in FIG. 1 and FIG. 2 according to some embodiments of the present disclosure. As illustrated, left of the FIG. 4 may illustrate the horizontal sectional view of the tunnel 1 and right of the FIG. 4 may illustrate the cross sectional view of the tunnel 1.

A method of placing the three-component detector 3 in the borehole 2 may be provided, as shown in FIG. 4 and FIG. 6. Taking an example of placing the first three-component detector 3a in the first borehole 2a, firstly, filling lithium-based grease 19 in the first borehole 2a and the lithium-based grease 19 is used as the coupling medium to fill the space between the three-component detector 3a and the borehole 2a. Secondly, adjusting the location of the first three-component detector 3a in the first borehole 2a to make a x-component direction of the first three-component detector 3a consistent with an axis direction of the tunnel 1 and pointing to the direction of the tunnel face 5, a y-component direction of the first three-component detector 3a perpendicular to the axis direction of the tunnel 1 in a horizontal plane, and a z-component direction of the first three-component detector 3a perpendicular to the axis direction of the tunnel 1 in a vertical plane. Thirdly, pressing the first three-component detector 3a hard to fit the first borehole 2a closely.

The method of placing the second three-component detector 3b in the second borehole 2b and the method of placing the third three-component detector 3c in the third borehole 2c may be the same as described above.

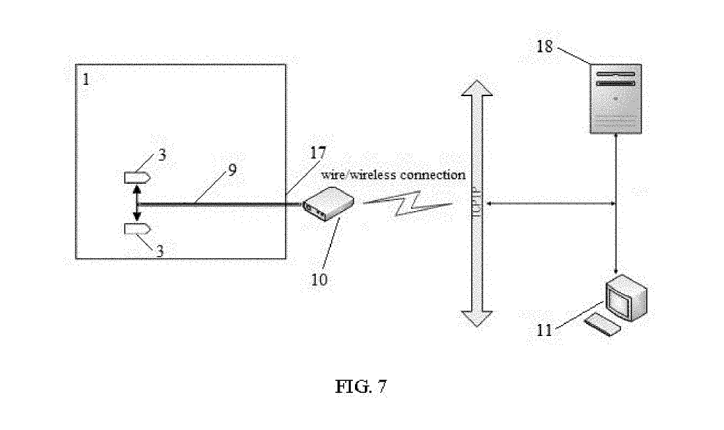

FIG. 7 is a schematic diagram of an exemplary application scenario of the automatic system for detecting problematic geological formations ahead the tunnel face 5 in FIG. 1 and FIG. 2 according to some embodiments of the present disclosure. As illustrated, the first three-component detector 3a, the second three-component detector 3b and the third three-component detector 3c may acquire the data independently and synchronously. The first three-component detector 3a, the second three-component detector 3b and the third three-component detector 3c may have no primary or secondary relations. The host 11 may transmit three synchronous trigger instructions to the first three-component detector 3a, the second three-component detector 3b and the third three-component detector 3c synchronously, so that the first three-component detector 3a, the second three-component detector 3b and the third three-component detector 3c may acquire the data synchronously.

The host 11 may set the acquisition parameter of the three-component detector 3 and transmit the instruction to the data acquisition module 12 via the data transmission module 14. The host 11 may control the data acquisition of the three-component detector 3 via the control and analysis procedure 11 of the host 11. The host 11 may transmit the acquisition parameter of the three-component detector 3 to the synchronous communicator 10 via Internet, and the synchronous communicator 10 may transmit the acquisition parameter of the three-component detector 3 to the three-component detector 3 via the signal line 9. In some embodiments, the signal line 9 may be the alternating current transmission line, for example, a voltage of the signal line 9 be 380V.

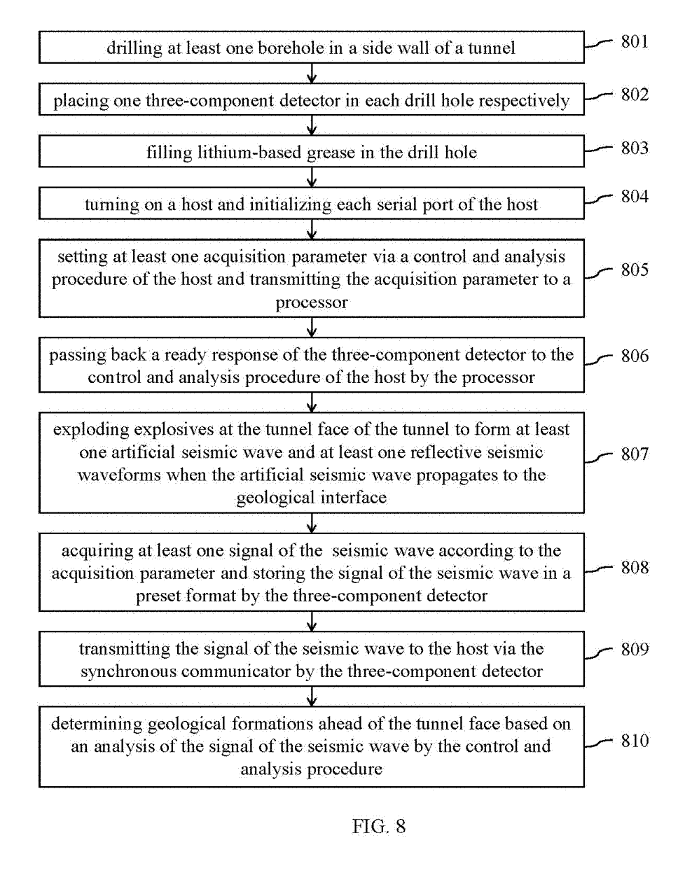

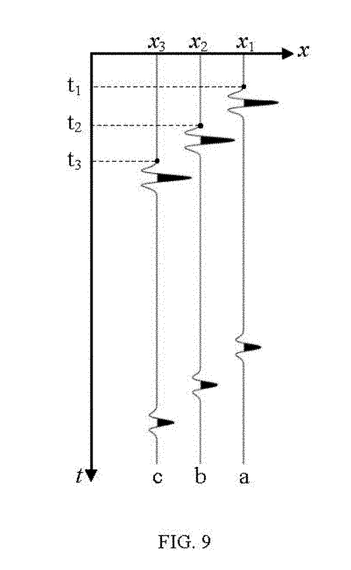

FIG. 8 is a flowchart illustrating an exemplary process/method for detecting problematic the geological formations ahead of the tunnel face 5 according to some embodiments of the present disclosure. The process and/or method may be executed by the response device of the state of the slip mass in the prefabricated magnetic field as exemplified in FIG. 1, FIG. 2, FIG. 3, FIG. 4, FIG. 5, FIG. 6, FIG. 7 and the description thereof. The operations of the illustrated process/method presented below are intended to be illustrative. In some embodiments, the process/method may be accomplished with one or more additional operations not described, and/or without one or more of the operations discussed. Additionally, the order in which the operations of the process/method as illustrated in FIG. 8 and described below is not intended to be limiting.

In step 801, at least one borehole 2 may be drilled in the side wall 4 of the tunnel 1. In some embodiments, three boreholes 2 (the first borehole 2a, the second borehole 2b and the third borehole 2c) may be drilled in the side wall 4 of the tunnel 1.

In step 802, one three-component detector 3 may be placed in each borehole 2 respectively. In some embodiments, three three-component detector 3 (the first three-component detector 3a, the second three-component detector 3b and the third three-component detector 3c) may be placed in three boreholes 2 (the first borehole 2a, the second borehole 2b and the third borehole 2c) respectively. In some embodiments, the three-component detector 3 may be placed in the borehole 2 as follows: the x-component direction and y-component direction of the three-component detector 3 may point to horizontal, the x-component direction of the three-component detector 3 may consistent with the axis direction of the tunnel 1 and point to the direction of the tunnel face 5, the y-component direction of the three-component detector 3 may perpendicular to the axis direction of the tunnel 1 in the horizontal plane, and the z-component direction of the three-component detector 3 may perpendicular to the axis direction of the tunnel 1 in the vertical plane.

In step 803, the lithium-based grease 19 may be filled in the borehole 2 to fill the space between the three-component detector 3 and the borehole 2. In some embodiments, firstly, the lithium-based grease 19 may be filled in the space of the borehole 2, secondly, the three-component detector 3 may be pressed hard to make the lithium-based grease 19 fill the space between the three-component detector 3 and the borehole 2, and make sure that the three-component detector 3 is coupled with the borehole 2 closely.

In step 804, the host 11 may be turned on and each serial port of the host 11 may be initialized.

In step 805, at least one acquisition parameter of the three-component detector 3 may be set via the control and analysis procedure 12 of the host 11, and the acquisition parameter may be transmitted to the processor 16 of the data acquisition module 13. In some embodiments, the acquisition parameter may include a sampling length, a sampling rate and a sampling trigger condition. An operator may set at least one acquisition parameter by operating the control and analysis procedure 12 of the host 11. The control and analysis procedure 12 may save the acquisition parameter automatically and transmit the acquisition parameter to the processor 16 of the data acquisition module 13. In some embodiments, the control and analysis procedure may transmit the acquisition parameter to the data acquisition module 13 via mobile networks or internet.

In step 806, the processor 16 of the data acquisition module 13 may pass back a ready response of the three-component detector 3 to the control and analysis procedure 12 of the host 11. The processor 16 of the data acquisition module 13 may control the three-component detector 3 to acquire the data.

In step 807, at least one artificial seismic wave 6 may form after blasting at the tunnel face 5. The reflected seismic wave 7 may form when the artificial seismic wave 6 propagates to the geological interface 8.

In step 808, the three-component detector 3 may start to acquire the data, as the signals of the reflected seismic wave 7, while the signals of the seismic wave received by the three-component detector 3 reaches a set value, and the three-component detector 3 will save the data in a preset format. FIG. 3 is a schematic diagram of three exemplary seismic waves recorded by the three three-component detectors respectively according to some embodiments of the present disclosure. As illustrated, the first three-component detector 3a may record an arrival time t₁ when it records the direct seismic waves 61 first time, the second three-component detector 3b may record the arrival time t₂ when it records the direct seismic waves 61 first time, and the third three-component detector 3e may record the arrival time t₃ when it records direct seismic waves 61 first time. A first arrival seismic velocity of surrounding rock may be determined based on the time t₁, t₂, t₃ and distances x₁, x₂, x₃ from the first three-component detector 3a, the second three-component detector 3b and the third three-component detector 3c to the tunnel entrance 17 respectively (as shown in formula (1)). A blast moment at the tunnel face 5 may be determined based on the first arrival seismic velocity and the distance from the tunnel face 5 to the tunnel entrance 17 (as shown in formula (2)).

$$v = \frac{1}{2} ( \frac{{x}_{1} - {x}_{2}}{{t}_{2} - {t}_{1}} + \frac{{x}_{2} - {x}_{3}}{{t}_{3} - {t}_{2}} ) \qquad ( 1 )$$

Wherein: “v” is the initial arrival seismic wave velocity of surrounding rock of tunnel 1; t₁ is the first time the first three-component detector 3a records, the seismic wave a, t₂ is the first time the second three-component detector 3b records the seismic wave b, t₃ is the first time the third three-component detector 3c records the seismic wave c; x₁ is a horizontal distance from the first three-component detector 3a to the tunnel entrance 17, x₂ is the horizontal distance from the second three-component detector 3b to the tunnel entrance 17, x₃ is the horizontal distance from the third three-component detector 3c to the tunnel entrance 17.

$${t}_{4} = {t}_{1} - \frac{{x}_{4} - {x}_{1}}{v}$$

Wherein t₁ is the blast moment at the tunnel, face 5, x₄ is the horizontal distance from the tunnel face 5 to the tunnel entrance 17. Therefore, the blast moment at the tunnel face 5 is accurately acquired.

In step 809, the data may be transmitted to the synchronous communicator 10 via the signal line 9 by the three-component detector 3, the data may be transmitted to the host 11 by the synchronous communicator 10 and the data may be displayed on the host 11. In some embodiments, the data may be displayed in a form of a curve on the host 11.

In step 810, the geological formations ahead of the tunnel face 5 may be predicted base on an analysis of the data transmitted from the synchronous communicator 10 by the control and analysis procedure 12 of the host 1l. In some embodiments, the control and analysis procedure 12 may predict the geological formations ahead of the tunnel face 5 based on a comparison of history data stored in the three-component detector 3.

Compared with the prior art, the present invention the following technical advantages and effects:

(1) The present invention takes the tunnel excavation blasting as seismic source which can form higher energy seismic waves. It thus greatly increases the distance of tunnel geological prediction.

(2) The present invention does not need works of drilling boreholes and packing explosives in the side walls of tunnel, which no longer occupies the tunnel construction time of the tunnel, reduces the labor intensity, speeds up the tunnel construction progress.

(3) The present invention provides an automatic detecting system which can acquire the data, store the data, transmit the data and supply power independently. So the detector can automatically acquire and transmit the signal of the seismic wave with the blasting of the tunnel face every time, which realizes the automation and normalization of geological prediction ahead of the tunnel face.

(4) The present invention provides an automatic detecting system which allows workers to operate the system outside of the tunnel and thus improve the working environment and reduce operational risk.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps may be added elsewhere in the exemplary process/method.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

What is claimed is:

1. An automatic system for detecting problematic geological formations ahead of a tunnel face, the automatic system comprising:
a data acquisition module, configured to acquire data, wherein the data acquisition module comprises at least one three-component detector and a processor, at least one borehole is drilled in a side wall of the tunnel, the three-component detector is placed in the borehole as follows: a x-component direction of the three-component detector is consistent with an axis direction of the tunnel and points to the direction of a tunnel face of the tunnel, a y-component direction of the three-component detector is perpendicular to the axis direction of the tunnel in a horizontal plane, and a z-component direction of the three-component detector is perpendicular to the axis direction of the tunnel in a vertical plane;
a data transmission module, configured to transmit the data, wherein the data transmission module comprises a synchronous communicator and a signal line with shielding properties, wherein the synchronous communicator is connected with the three-component detector via the signal line to receive data acquired by the data acquisition module;
a control and data analysis module, configured to receive and analysis the data, and determine the geological formations of the tunnel face based on the data, wherein the control and data analysis module comprises a host and a control and analysis procedure of the host, and the host is connected with the synchronous communicator.

2. The automatic system of claim 1, wherein three boreholes, namely, a first borehole, a second borehole and a third borehole are drilled in the side wall of the tunnel.

3. The automatic system of claim 2, wherein the tunnel comprises a base which is perpendicular to the tunnel face, the first borehole, the second borehole, and the third borehole are drilled parallel to the base plate of the tunnel and perpendicular to an axis direction of the tunnel.

4. The automatic system of claim 3, wherein the data acquisition module comprising three three-component detectors, wherein the three three-component detectors placed in the first borehole, the second borehole and the third borehole are named as a first three-component detector, a second three-component detector and a third three-component detector, respectively.

5. The automatic system of claim 4, wherein the three three-component detectors acquire the data independently and synchronously and the three three-component detectors are connected with each other via the signal line.

6. The automatic system of claim 1, wherein lithium-based grease is used as a coupling medium to fill space between the three-component detector and the borehole wall.

7. The automatic system of claim 1, wherein the three-component detector acquires the data automatically, converts analogue signal to digital signal, stores the data, transmits the data and supplies power independently.

8. The automatic system of claim 1, wherein the synchronous communicator is connected with the host via wire or wireless connection, and the signal line is an alternating current transmission line.

9. The automatic system of claim 1, wherein the synchronous communicator transmits the data acquired by the data acquisition module to a server.

10. The automatic system of claim 10, wherein the server comprises a particular server and a cloud server.

11. The automatic system of claim 1, wherein the synchronous communicator is placed at a tunnel entrance of the tunnel.

12. The automatic system of claim 1, wherein the borehole is parallel to a base plate of the tunnel and perpendicular to an axis direction of the tunnel.

13. The automatic system of claim 1, wherein the host sets at least one acquisition parameter of the three-component detector, transmits an instruction to the data acquisition module, displays and records the data.

14. An automatic method for detecting problematic geological formations ahead of tunnel faces, comprising:
drilling at least one borehole in a side wall of the tunnel;
placing one three-component detector in each borehole respectively;
filling lithium-based grease in the borehole;
turning on a host and initializing each serial port of the host, wherein the host is connected with a synchronous communicator which is connected with the three-component detector via a signal line;
setting at least one acquisition parameter via a control and analysis procedure of the host and transmitting the acquisition parameter to a processor, wherein the processor is configured to control the three-component detector;
passing back a ready response of the three-component detector to the control and analysis procedure of the host by the processor;
exploding explosives at the tunnel face to form at least one artificial seismic wave, wherein at least one reflected seismic wave forms when the artificial seismic wave propagates to geological interface;
acquiring at least one signal of the seismic wave according to the acquisition parameter and storing the signal of the seismic wave in a preset format by the three-component detector;
transmitting the signal of the seismic wave to the host via the synchronous communicator by the three-component detector;
determining the geological formations ahead of the tunnel face based on an analysis of the signal of the seismic wave by the control and analysis procedure.

15. The automatic method of claim 14, wherein the placing one three-component detector in each borehole respectively is conducted as follows: a x-component direction of the three-component detector is consistent with an axis direction of the tunnel and points to the direction of the tunnel face of the tunnel, a y-component direction of the three-component detector is perpendicular to the axis direction of the tunnel in a horizontal plane, and a z-component direction of the three-component detector is perpendicular to the axis direction of the tunnel in a vertical plane.

16. The automatic method of claim 14, wherein the filling lithium-based grease in the borehole is conducted as follows:
filling the lithium-based grease in space of the borehole; and
pressing hard the three-component detector to make the lithium-based grease fill the space between the three-component detector and the borehole walls.

17. The automatic method of claim 14, wherein the acquisition parameter comprises a sampling length, a sampling rate and a sampling trigger condition.

18. The automatic method of claim 14, wherein the acquiring at least one signal of the seismic wave according to the acquisition parameter is conducted as follows: the three-component detector starts to acquire the signal of the seismic wave according to the acquisition parameter while the signal of the seismic wave received by the three-component detector reaches a set value, wherein the three-component detector automatically acquire the signal of the seismic wave in the blasting of tunneling every time.

19. The automatic detecting method of claim 14, wherein three boreholes are drilled in the side wall of the tunnel and three three-component detectors are placed in each borehole respectively, a first arrival seismic velocity of the surrounding rock is determined based on three arrival times that the three three-component detectors record the seismic wave first time respectively and distances from the three three-component detectors to tunnel entrance respectively.

20. The automatic method of claim 19, wherein a blast moment at the tunnel face is determined based on the first arrival seismic velocity and the distance from the tunnel face to the tunnel entrance.
